(19) United States
(12) Patent Application Publication
(10) Pub. No.: US 2007/0180130 A1
(43) Pub. Date: Aug. 2, 2007

(54) Method and apparatus for multi-protocol digital communications

(76) Inventors: William C. Arnold, Mahopac, NY (US); David M. Chess, Mohegan Lake, NY (US); James E. Hanson, Yorktown Heights, NY (US); Edward C. Snible, Bronx, NY (US); Ian N. Whalley, Pawling, NY (US)

Correspondence Address: MOSER, PATTERSON & SHERIDAN LLP;IBM CORPORATION, 595 SHREWSBURY AVE, SUITE 100, SHREWSBURY, NJ, 07702, US

(21) Appl. No.: 11/344,859

(22) Filed: Feb. 1, 2006

(51) Int. Cl. G06F 15/16

(52) U.S. Cl. 709/230

(57) ABSTRACT

One embodiment of the present method and apparatus for multi-protocol digital communications conducts a first portion of a communication between a first information processing device and a second information processing device in accordance with a first communication protocol. A second portion of the communication is conducted in accordance with at least a second communication protocol, where the second communication protocol is different from the first communication protocol. The communication may be divided into further portions, where each portion of the communication is conducted in accordance with a different communication protocol.

### FIELD OF THE INVENTION

The present invention relates generally to digital communication and relates more particularly to communication protocols used in digital communication.

### BACKGROUND

Most digital communications (e.g., between information processing devices such as desktop computers, laptop computers, personal digital assistants, cellular phones, gaming consoles and the like) conform to a relatively well-defined communication protocol (e.g., hypertext transfer protocol or HTTP, simple mail transfer protocol or SMTP, file transfer protocol or FTP, secure socket layer or SLL, etc.) that enables interoperability. If both devices participating in a communication adhere to the same communication protocol, successful communication is more likely, even in cases where the devices have never directly communicated before. Thus, a given communication typically uses a single protocol for its entire duration.

Although adherence to a single protocol is simple and improves the chances of successful communication, it also comes with several drawbacks. For instance, another protocol other than that selected for a given communication may offer better performance for that communication under the given circumstances (e.g., due to the configuration of intermediate network components on a path between the communicating devices). Moreover, the use of a single protocol may make it easy for potential attackers to observe one of the communicating devices or one of the intermediate communication links, to observe the communication itself or even to alter the communication.

Thus, there is a need in the art for a method and apparatus for multi-protocol digital communications (e.g., protocol “hopping”).

### SUMMARY OF THE INVENTION

One embodiment of the present method and apparatus for multi-protocol digital communications conducts a first portion of a communication between a first information processing device and a second information processing device in accordance with a first communication protocol. A second portion of the communication is conducted in accordance with at least a second communication protocol, where the second communication protocol is different from the first communication protocol. The communication may be divided into further portions, where each portion of the communication is conducted in accordance with a different communication protocol.

### BRIEF DESCRIPTION OF THE DRAWINGS

So that the manner in which the above recited embodiments of the invention are attained and can be understood in detail, a more particular description of the invention, briefly summarized above, may be obtained by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram illustrating one embodiment of a method for multi-protocol communications, according to the present invention;

FIG. 2 is a flow diagram illustrating one embodiment of a method for selecting and modifying a communication protocol, in accordance with the present invention; and

FIG. 3 is a high level block diagram of the protocol hopping method that is implemented using a general purpose computing device.

To facilitate understanding, identical reference numerals have been used, where possible, to designate identical elements that are common to the figures.

### DETAILED DESCRIPTION

In one embodiment, the present invention is a method and apparatus for multi-protocol digital communications. Embodiments of the present invention provide for “protocol hopping” or the switching of communication protocols mid-communication. The varying of communication protocols over the duration of a communication event makes it more difficult for outside parties (e.g., potential attackers) to observe, alter or otherwise disrupt the communication event. Moreover, the quality of the communication event may be improved by enabling the best performing communication protocol to be used at any given time, rather than use a single communication protocol whose performance may be inferior and/or variable.

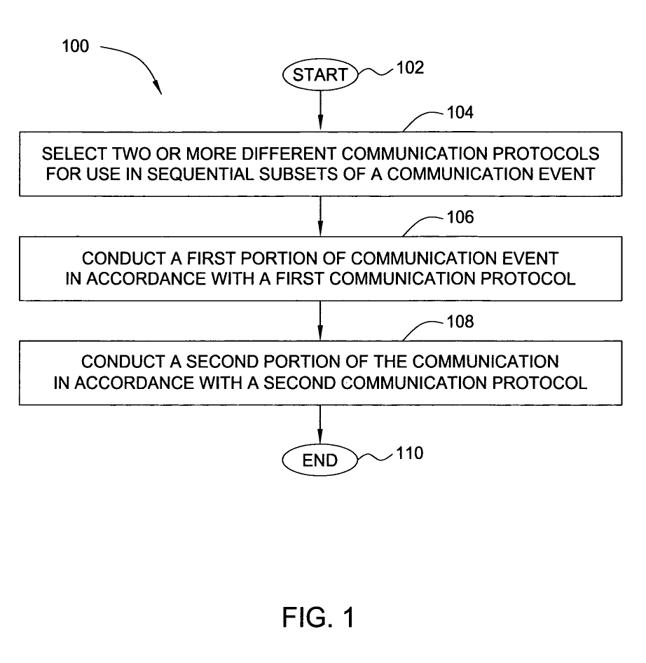

FIG. 1 is a flow diagram illustrating one embodiment of a method 100 for multi-protocol communications, according to the present invention. The method 100 may be implemented, for example, at a first information processing device that communicates over a network with one or more other information processing devices.

The method 100 is initialized at step 102 and proceeds to step 104, where the method 100 selects two or more different communication protocols (e.g., HTTP, SMTP, FFP, SSL or the like) for use in a communication event with a second information processing device.

In step 106, the method 100 conducts a first portion of the communication event, in accordance with a first communication protocol from the group of two or more selected communication protocols. In one embodiment, the first communication protocol is selected from a library of known common communication protocols. In another embodiment, the first communication protocol is created dynamically (e.g., using a protocol generation algorithm). In yet another embodiment, the first protocol comprises a common or known protocol that is modified by using different values for one or more default values or fixed parameters (e.g., header length, integer length, padding bytes, etc.) and/or by varying the order in which values are stored in headers and similar data structures.

In step 108, the method 100 conducts a second portion of the communication event, in accordance with a second communication protocol from the group of two or more selected communication protocols. That is, the method 100 switches, during the same communication event, to a second communication protocol. In one embodiment, the second communication protocol is a known common communication protocol (e.g., selected from a library), a modified communication protocol or a dynamically created communication protocol, as discussed above with respect to the first communication protocol.

Although the method 100 describes a communication event divided into two separate portions, it will be appreciated that the communication event may be divided into a plurality of individual portions or subsets, where variation in the communication protocol used occurs at least once over the duration of the communication event. The individual portions of the communication event and their associated communication protocols may be pre-selected (e.g., before the communication event commences) or may be selected dynamically (e.g., over the course of the communication event).

In one embodiment, the decision as to when to switch to the second communication protocol is made in accordance with a meta-protocol (which can also be variable over time) exchanged by the first and second information processing devices that defines when to switch communication protocols and to which communication protocol or protocols to switch. In another embodiment, the decision as to when to switch to the second communication protocol (and which protocol should comprise the second protocol) is made in accordance with calculations based on information shared by the first and second information processing devices (e.g., a shared secret or other binary data).

In further embodiments, the choices of communication protocols for the first and/or second communication protocols is based at least in part on observed characteristics and/or the behavior of the communication link(s) between the first and second information processing devices. For example, the method 100 might be adapted to prefer communication protocols that have performed well in the past (or are similar to communication protocols that have performed well in the past), either in a previous communication event or in a previous portion of the current communication event. Thus, the method 100 may actively seek out communication protocols that performed particularly well on a given communication link or to a given information processing device, e.g., due to preferential routing or other characteristics of the network.

In yet another embodiment, communication protocols may be changed in accordance with a sequence of unpredictably changing algorithms or criteria produced, for example, using known cryptography methods. In this manner, the method by which communication protocols are chosen, or by which times at which to change communication protocols are chosen, also varies over the duration of the communication event.

In yet another embodiment, changing communication protocol choices may additionally convey at least part of the message being conveyed during then communication event. In this manner, it is made more difficult for outsiders to fully reconstruct the message (e.g., because details of the communication protocols used in the communication event are needed in addition to the contents of the communication event). In some such embodiments, aspects of the communication protocol choices that encode parts of the message are not identified until all other relevant parts of the message have been transmitted (e.g., so that an outsider must save a potentially large amount of data before being able to determine how to decode the message). For example, part of a cryptographic key required to decode a message may be contained in the sizes of the packet fragments sent in a standard transmission control protocol (TCP) data stream during a first subset of a communication event, and sent in the sizes of the data areas of the invalid user datagram protocol (UDP) packets of a UDP-based communication protocol during a second subset of the communication event. The fact that the cryptographic key is encoded in these values might not be transmitted until a third subset of the communication event.

The method 100 then terminates in step 110.

The method 100 thereby enables performance and security for communications over a network by making it possible for a single communication event to “hop” between multiple communication protocols over sequential subsets of the communication event. In this manner, an optimally performing communication protocol may be selected at various points in a communication event to improve the quality of the communication event. Moreover, the unpredictability of the protocol hopping makes it more difficult for outsiders to observe or alter the communication event.

The present invention may also be implemented to improve gaming applications. For example, where the information processing devices participating in the communication event comprise a gaming server and a gaming client, the present invention may be implemented to thwart strategies typically used to cheat at multi-player Internet-based games. Many such strategies depend on the ability to analyze the communication protocol used between the gaming server and the gaming client, and intervening to capture or alter the information flowing across the communication link (e.g., in order to locate other players who would normally be invisible or to enable more accurate shooting). Such strategies can be made substantially less effective by periodically altering the communication protocol used between the gaming server and the gaming client, as discussed above.

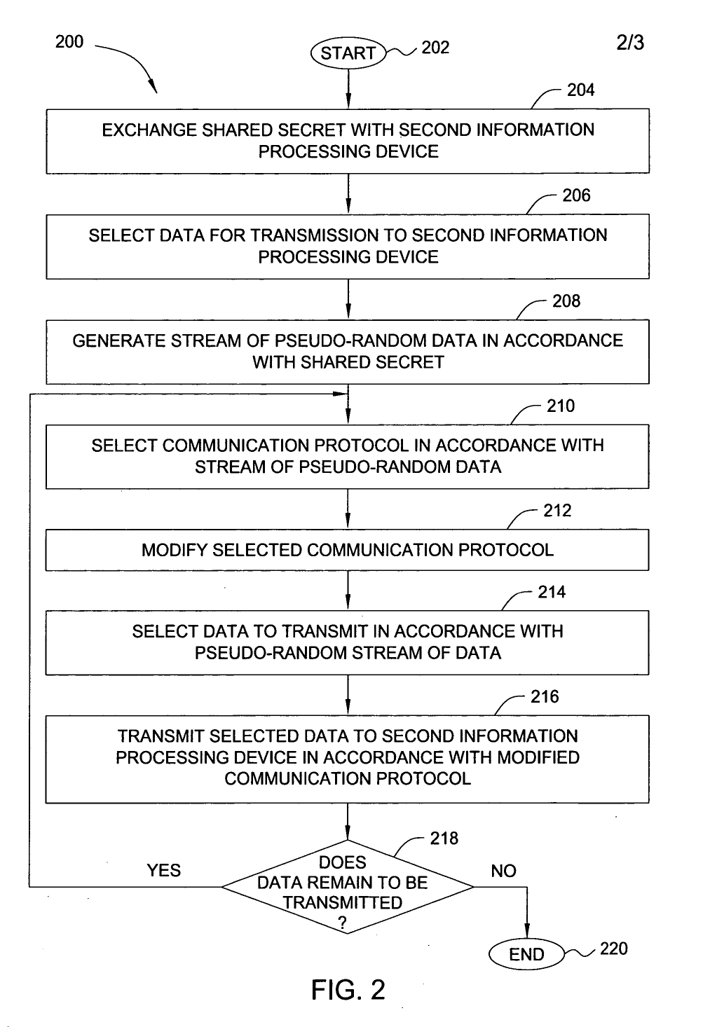

FIG. 2 is a flow diagram illustrating one embodiment of a method 200 for selecting and modifying a communication protocol, in accordance with the present invention. Like the method 100, the method 200 may be implemented, for example, at a first information processing device that communicates over a network with one or more other information processing devices.

The method 200 is initialized at step 202 and proceeds to step 204, where the method 200 exchanges a shared secret with a second information processing device (e.g., by a key-exchange or other known mechanism).

In step 206, the method 200 selects data for transmission to the second communication processing device. The method 200 then proceeds to step 208 and generates a stream of pseudo-random data (bits) in accordance with the shared secret exchanged in step 204. For example, the method 200 may implement a known algorithm in accordance with the shared secret to generate the pseudo-random stream of data. Suitable such algorithms may include, but are not limited to, those discussed by U. V. Vazirani and V. V. Vazirani in “Efficient and Secure Pseudo-Random Number Generation”, Springer Lecture Notes in Computer Science No. 196, pp. 193-202. This pseudo-random stream of data will be the same for any parties sharing the same secret, but will be extremely difficult for an outside party not sharing the secret to recreate or predict.

In step 210, the method 200 selects a communication protocol in accordance with the stream of pseudo-random data generated in step 208. In one embodiment, step 210 involves using a plurality of bits from the pseudo-random stream of data to generate an index into a table of basic communication protocols (e.g., HTTP, FTP, SMTP, etc.). A communication protocol in the table corresponding to the index is selected.

In step 212, the method 200 modifies the selected communication protocol, in accordance with the stream of pseudo-random data. In one embodiment, additional bits from the stream of pseudo-random data are used to make the modifications. In one embodiment, such modifications might be made to at least one of: sizes of padding bytes in headers, orders of values in headers, amounts of data transmitted in each separate packet of the selected communication protocol, special markers or symbols used as “handshakes” in initiating and operating a connection according to the selected communication protocol (e.g., “HELO” symbols in an SMTP communication) or sizes of (number of bytes in) various numeric fields used in the selected communication protocol. In one embodiment, a communication protocol's entry in the table of basic communication protocols includes a list of potential modifications that may be made to the communication protocol.

In step 214, the method 200 selects data to transmit to the second information processing device, in accordance with the stream of pseudo-random data. The method 200 then proceeds to step 216 and transmits the selected data to the second information processing device, in accordance with the modified communication protocol.

In step 218, the method 200 determines whether any data remains to be transmitted to the second information processing device. If no data remains to be transmitted, the method 200 terminates in step 220.

Alternatively, if the method 200 determines in step 218 that data does remain to be transmitted, the method 200 returns to step 210 and proceeds as described above, e.g., in order to send at least a portion of the remaining data to the second information processing device in accordance with a further modified communication protocol. Thus, the data is transmitted to the second information processing device in groups, where each group is transmitted in accordance with a different communication protocol. Such groups may be formed dynamically during the course of the transmission. Moreover, it will be appreciated that the communication protocols used in accordance with the method 200 may each be selected before the transmission of the associated data to be transmitted in accordance with the protocol(s).

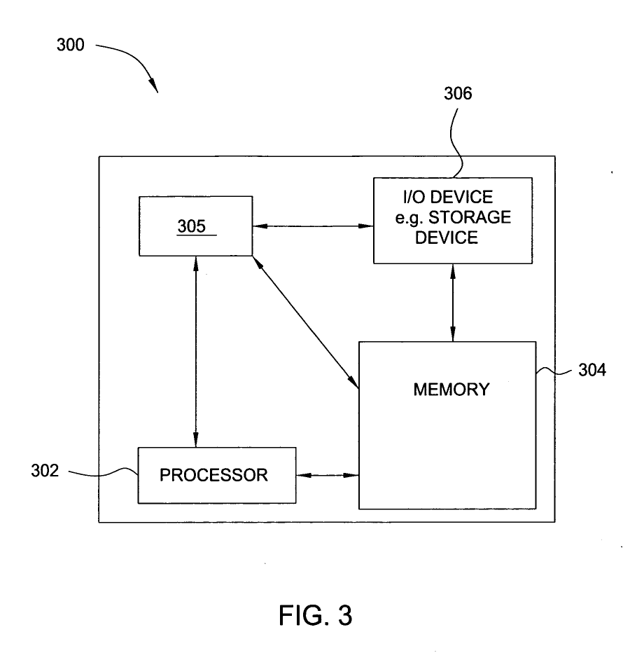

FIG. 3 is a high level block diagram of the protocol hopping method that is implemented using a general purpose computing device 300. In one embodiment, a general purpose computing device 300 comprises a processor 302, a memory 304, a protocol hopping module 305 and various input/output (I/O) devices 306 such as a display, a keyboard, a mouse, a modem, and the like. In one embodiment, at least one I/O device is a storage device (e.g., a disk drive, an optical disk drive, a floppy disk drive). It should be understood that the protocol hopping module 305 can be implemented as a physical device or subsystem that is coupled to a processor through a communication channel.

Alternatively, the protocol hopping module 305 can be represented by one or more software applications (or even a combination of software and hardware, e.g., using Application Specific Integrated Circuits (ASIC)), where the software is loaded from a storage medium (e.g., I/O devices 306) and operated by the processor 302 in the memory 304 of the general purpose computing device 300. Thus, in one embodiment, the protocol hopping module 305 for multi-protocol communications described herein with reference to the preceding Figures can be stored on a computer readable medium or carrier (e.g., RAM, magnetic or optical drive or diskette, and the like).

Thus, the present invention represents a significant advancement in the field of digital communications. A method and apparatus are provided that enable “protocol hopping” or the switching of communication protocols mid-communication. The varying of communication protocols over the duration of a communication event makes it more difficult for outside parties (e.g., potential attackers) to observe, alter or otherwise disrupt the communication event. Moreover, the quality of the communication event may be improved by enabling the best performing communication protocol to be used at any given time, rather than use a single communication protocol whose performance may vary.

While foregoing is directed to the preferred embodiment of the present invention, other and further embodiments of the invention may be devised without departing from the basic scope thereof, and the scope thereof is determined by the claims that follow.

1. A method for communication between a first information processing device and a second information processing device in a network, said method comprising the steps of:
selecting two or more different communication protocols for use in two or more sequential subsets of a communication between said first information processing device and said second information processing device;
conducting a first portion of said communication in accordance with a first communication protocol from said selected two or more communication protocols; and
conducting a second portion of said communication in accordance with at least a second communication protocol from said selected two or more communication protocols.

2. The method of claim 1, wherein at least one of the first communication protocol and the second communication protocol is selected from a library of communication protocols.

3. The method of claim 1, wherein at least one of the first communication protocol and the second communication protocol is created dynamically.

4. The method of claim 1, wherein at least one of the first communication protocol and the second communication protocol is a modified version of a common communication protocol.

5. The method of claim 4, where said modifications are made by at least one of: using a different value for at least one default value or varying an order in which two or more values are stored in a header.

6. The method of claim 1, wherein a point in said communication at which said first communication protocol is replaced with said second communication protocol is selected in accordance with a meta-protocol exchanged by the first information processing device and the second information processing device.

7. The method of claim 6, wherein said meta-protocol is variable over time.

8. The method of claim 6, wherein said meta-protocol further specific how to select said second protocol.

9. The method of claim 1, wherein a point in said communication at which said first communication protocol is replaced with said second communication protocol is selected in accordance with at least one calculation based on information shared by the first information processing device and the second information processing device.

10. The method of claim 9, wherein said information is at least one of: a shared secret or binary data.

11. The method of claim 1, wherein a point in said communication at which said first communication protocol is replaced with said second communication protocol is selected in accordance with a sequence of unpredictably changing algorithms.

12. The method of claim 1, wherein a selection of a communication protocol comprising said second communication protocol is made in accordance with at least one observed characteristic of at least one previous communication over said network.

13. The method of claim 12, wherein said at least one observed characteristic is a performance of at least one communication protocol used in said at least one previous communication.

14. The method of claim 1, wherein at least one of said first communication protocol and said second communication protocol is selected prior to a start of said communication.

15. The method of claim 1, wherein selection of at least one of said first communication protocol and said second communication protocol is made so as to encode at least a portion of said communication.

16. The method of claim 15, wherein information required to decode said at least a portion of said communication is sent only after said at least a portion of said communication is sent.

17. The method of claim 1, wherein said communication is dynamically divided into said first portion and said second portion during a course of said communication.

18. A computer readable medium containing an executable program for communication between a first information processing device and a second information processing device in a network, said method comprising the steps of:
selecting two or more different communication protocols for use in two or more sequential subsets of a communication between said first information processing device and said second information processing device;
conducting a first portion of said communication in accordance with a first communication protocol from said selected two or more communication protocols; and
conducting a second portion of said communication in accordance with at least a second communication protocol from said selected two or more communication protocols.

19. The computer readable medium of claim 18, wherein at least one of said first communication protocol and said second communication protocol is selected prior to a start of said communication.

20. Apparatus for communication between a first information processing device and a second information processing device in a network, said method comprising the steps of:
means for selecting two or more different communication protocols for use in two or more sequential subsets of a communication between said first information processing device and said second information processing device;
means for conducting a first portion of said communication in accordance with a first communication protocol from said selected two or more communication protocols; and
means for conducting a second portion of said communication in accordance with at least a second communication protocol from said selected two or more communication protocols.
